(19) United States
(12) Patent Application Publication
(10) Pub. No.: US 2009/0093306 A1
(43) Pub. Date: Apr. 9, 2009

(54) Method of controlling a touch screen display and a gaming system for a multi-player game

(75) Inventors: Robert Linley Muir, Lane Cove (AU); Martin Stephen Lyons, Lane Cove (AU)

Correspondence Address: MCANDREWS HELD & MALLOY, LTD, 500 WEST MADISON STREET, SUITE 3400, CHICAGO, IL, 60661, US

(73) Assignee: Aristocrat Technologies Australia Pty Limited, Lane Cove NSW (AU)

(21) Appl. No.: 12/134,139

(22) Filed: Jun. 5, 2008

(30) Foreign Application Priority Data
Jun. 7, 2007 (AU) 2007903067

(51) Int. Cl. G06F 17/00

(52) U.S. Cl. 463/37

(57) ABSTRACT

A gaming system having multiple player participation via a touch screen display interface. In response to the addition of a new player, an existing player interface is added by adjusting the touch screen display.

### RELATED APPLICATIONS

This application claims priority to Australian Provisional Patent Application No. 2007903067, having an international filing date of Jun. 6, 2007, entitled “Method of Controlling a Touch Screen Display and a Gaming System for a Multi-Player Game,” which is hereby incorporated by reference herein in its entirety.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

The present invention relates to a method of controlling a touch screen display of a multi-player game and a gaming system for a multi-player game.

Traditionally, electronic gaming machines have taken the form of slot machines where a player plays a game involving reels that spin and prizes are awarded based on the position at which the reels stop relative to win lines selected by the player. Originally, these machines were mechanical with physically rotating reels. In many modern slot machines, the mechanical reels have been replaced by “virtual reels” displayed as spinning on a video display.

More recently, there has been a move towards implementing other types of games such as table games including poker, blackjack or roulette on electronic gaming machines. Motivations for doing so include that less staff may be required and games can be played more quickly when a human dealer or croupier is replaced by a gaming machine.

As such games are developed, there is a need to provide electronic display techniques which suit these game types.

### BRIEF SUMMARY OF THE INVENTION

In a first aspect, the invention provides a method of controlling a touch screen display of a multi-player game comprising:
determining that an additional player interface is required for the game; and
adding to the touch screen display a new player interface operable to play the game.

In an embodiment, the method comprises determining that an additional player interface is required comprises determining that a new player is to participate in the game.

In an embodiment, the method comprises determining that an additional player interface is required comprises determining that an existing player requires an additional interface.

In an embodiment, the method comprises adjusting at least one existing player interface in response to addition of a new player.

In an embodiment, the method comprises adjusting at least one existing player interface by moving an existing player interface.

In an embodiment, the method comprises adjusting at least one existing player interface by changing the size of an existing player interface.

In an embodiment, the method comprises determining a position for the new player interface based on the position of at least one existing player interface.

In an embodiment, the method comprises obtaining position information indicative of a player's position relative to the display and determining a position on the player interface at which to add the new player interface based on the position information.

In a second aspect, the invention provides a gaming system for a multi-player game comprising:

a touch screen display;

a new interface determiner arranged to determine that an additional player interface is required for the game; and

a player interface adder arranged to add to the touch screen display, an additional player interface operable to play the game.

In an embodiment, the new interface determiner is arranged to determine that an additional player interface is required by determining that a new player is to participate in the game.

In an embodiment, the new interface determiner is arranged to determine that an additional player interface is required by determining that an existing player requires an additional interface.

In an embodiment, the gaming system further comprises an interface adjuster arranged to adjust at least one existing player interface in response to addition of a new player.

In an embodiment, the interface adjuster is arranged to adjust at least one existing player interface by moving an existing player interface.

In an embodiment, the interface adjuster is arranged to adjust at least one existing player interface by changing the size of an existing player interface.

In an embodiment, the gaming system comprises a position acquirer arranged to obtain position information indicative of the player's position relative to the display and a position determiner arranged to determine a position on the player interface at which the player interface adder adds the new player interface based on the position information.

In an embodiment, the position acquirer comprises at least one sensor for sensing a player position.

In an embodiment, the position acquirer comprises at least one identification reader for reading an identification device carried by the player.

In an embodiment, the gaming system comprises a plurality of identification readers arranged to enable the player's position to be determined.

In an embodiment, the display is mounted so that an upper surface thereof is substantially horizontal such that the display provides a virtual table.

In an embodiment, the display comprises a plurality of display sub-units.

In a third aspect, the invention provides computer program code which when executed by a computer causes the computer to implement the above method.

In a fourth aspect, the invention provides a computer readable medium comprising the above computer program code.

In a fifth aspect, the invention provides a data signal comprising the above computer program code.

In a sixth aspect, the invention provides transmitting or receiving the above computer program code.

### BRIEF DESCRIPTION OF SEVERAL VIEWS OF THE DRAWINGS

An embodiment of the invention will now be described in relation to the accompanying drawings in which:

FIG. 1 is a plan view of a gaming table of an embodiment;

FIG. 2 is a functional block diagram of a gaming system on an embodiment;

FIG. 3 is a further block diagram showing the interface controller in more detail;

FIG. 4 is a schematic diagram showing a networked embodiment;

FIGS. 5a and 5b are exemplary displays of the gaming system;

FIGS. 6a and 6b are further exemplary displays; and

FIG. 7 is a flow chart of the method of the embodiment.

### DETAILED DESCRIPTION OF THE INVENTION

Referring to the drawings, there is shown a gaming system arranged to implement a virtual gaming table, where a horizontally oriented touch screen display is used by players to participate in a game. The gaming system can take a number of different forms.

In a first form, a stand alone gaming table is provided wherein all or most components required for implementing the game are present or located next to a player operable virtual gaming table.

In a second form, a distributed architecture is provided wherein some of the components required for implementing the game are present located with the gaming table player operable gaming machine and some of the components are located remotely relative to the gaming table. For example, a “thick client” architecture may be used wherein part of the game is executed locally by the player operable gaming table and part of the game is executed remotely, such as by a gaming server; or a “thin client” architecture may be used wherein most of the game is executed remotely such as by a gaming server and a player operable gaming table is used only to display audible and/or visible gaming information to the player and receive gaming inputs from the player.

However, it will be understood that other arrangements are envisaged. For example, an architecture may be provided wherein a gaming table is networked to a gaming server and the respective functions of the gaming table and the gaming server are selectively modifiable. For example, the gaming system may operate in stand alone gaming table mode, “thick client” mode or “thin client” mode depending on the game being played, operating conditions, and so on. Other variations will be apparent to persons skilled in the art.

Persons skilled in the art will appreciate that the reference to random numbers includes pseudo-random numbers.

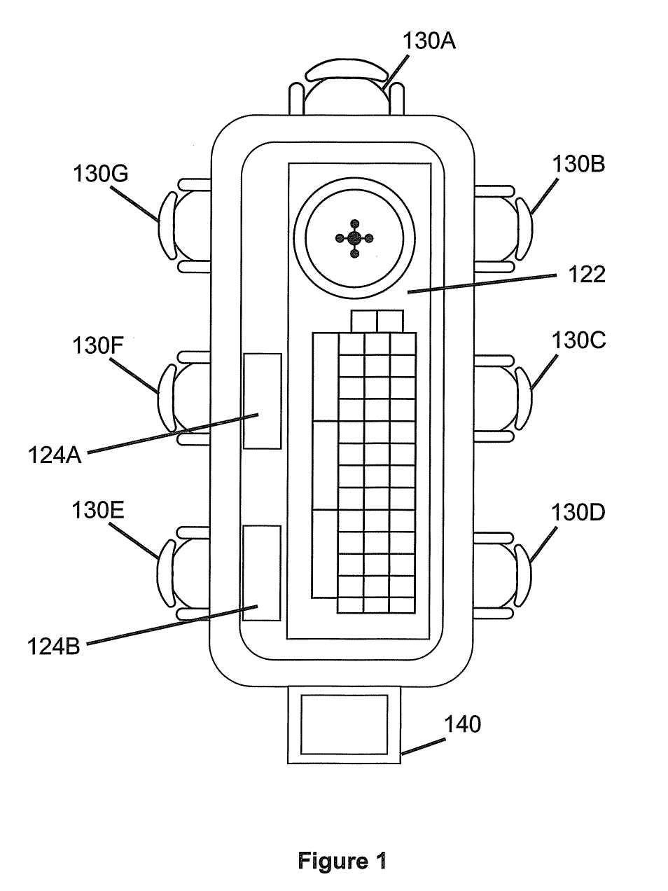

FIG. 1 is a plan view of a virtual gaming table 100 having a horizontally oriented display 120 and a log-on terminal 140. As can been from FIG. 1, the gaming table is surrounded by seven chairs 130 indicating seven possible player positions. Two player interfaces 124a, 124b are active on the display 120. A central area 122 of the display is used to display information common to all players; in the example shown in FIG. 1 a display of a roulette game.

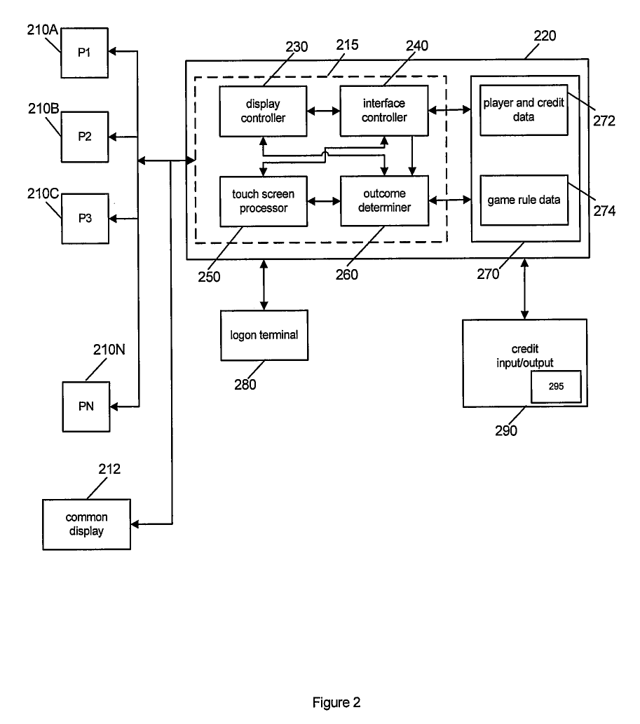

As shown in FIG. 2, from a functional perspective, a virtual table 200 comprises a game controller 220, a common display 212 and a variable number of player interfaces 210. As described in detail below, in the embodiment the number of player interfaces depends on the number of players playing the game. In some embodiments there may be a single player interface for each player so that each time a player enters the game an interface is added. In other embodiments, a minimum number of player interfaces may always be displayed even though it is possible they are not all being used and additional player interfaces added as necessary when the minimum is exceeded; unused interfaces may function in an attract mode. In further embodiments, a player may request an additional player interface. For example, some players may wish to play two hands of cards simultaneously where the gaming table implements a card game.

In the embodiment, a number of the modules are implemented by a processor 215. However, a person skilled in the art will appreciate that dedicated hardware could be used instead of program code running on a processor 215 to implement the required functions.

The game controller's processor 215 typically processes the game play instructions in accordance with game play rules and outputs game play outcomes to the display. Typically, the game play instructions are stored as program code in a memory. Herein the term “processor” is used to refer generically to any device that can process game play instructions in accordance with game play rules and may include: a microprocessor, microcontroller, programmable logic device or other computational device, a general purpose computer (e.g. a PC) or a server.

These functions are carried out based on data such as player and credit data 272 and game rule data 274 stored in a memory 270 of the game controller 220. The game controller 220 has a display controller 230 for controlling what is displayed both in the common display area 212 of a gaming table 212 and on each of the player interfaces 210.

The display 120 incorporates a touch screen. Herein such a display is referred to as “touch screen display”. Accordingly, it will be appreciated that the player interfaces share a common display 120. A person skilled in the art will appreciate that the “touch screen” sensor need not cover the entire display. For example central area 122 as shown in FIG. 1 need not necessarily have a touch screen capability. In the embodiment, the touch screen is a multi-touch screen capable of processing simultaneous or near simultaneous instructions from a number of different players. The display 120 itself is typically a wide screen, large format display such as a plasma or LCD display of a size in the order of 80-120 inches across the diagonal. However, a person skilled in the art will appreciate that the display could be formed a plurality of display sub-units located adjacent to one another under the control of the display controller 230 to display both the player interfaces 210 and the common display area 212.

The display controller 230 controls the display to display the individual player interfaces based on data provided by the interface controller 240 and the outcome determiner. The interface controller also provides data to the touch screen processor 250 to enable it to interpret touches on the touch screen display in order to associate them with individual player interfaces 210 and to provide this data to the outcome determiner 260. In this manner, individual player instructions can be correctly provided to the outcome determiner 260 so that the outcome determiner 266 can determine the result of the game based on the game rule data 274 for each player. Similarly, the outcome determiner 260 provides data to the display controller 230 regarding the game outcomes for individual players. This may be displayed in a display region of the player interface 210 on the common display or both.

A person skilled in the art will appreciate that depending on the game, the outcome determiner 260 may determine independent results for each player such as in a game like roulette or results that depend on the game play of other players such as in a competitive game like poker. Credit data 272 is maintained separately for each player interface in memory 270. That data may be associated with a specific player and the players identity captured either via the log-on terminal 280 or in some other manner as will be described in further detail. The log-on terminal 280 will typically include a touch screen display allowing a player to enter their name and assigned to themselves a player position number. Alternatively the player position maybe assigned by the game. In alternative embodiments, players may be assigned positions anonymously by providing them with a temporary access code, printed by the log-on terminal on a voucher.

A credit input/output mechanism 290 can either be provided centrally, for example in association with the log-on terminals so that the player enters credit when they log-on to the game. A credit mechanism can also be provided at each player position. For example, by a bill acceptor located under the table.

In one embodiment, the credit input/output mechanism includes a voucher printer 295. A player provides credit to the credit input/output 290 using a bill or coin acceptor. The credit mechanism 290 creates a record in credit data 272 having an access code. A voucher is printed by a voucher printer 295. The voucher has the code on it so that the player can enter at the player interface 210 using a virtual key pad. The game controller 220 processes the input code and verifies it against records stored as credit data 272. If the code is verified, the amount of credit is associated with the player interface used to enter the code.

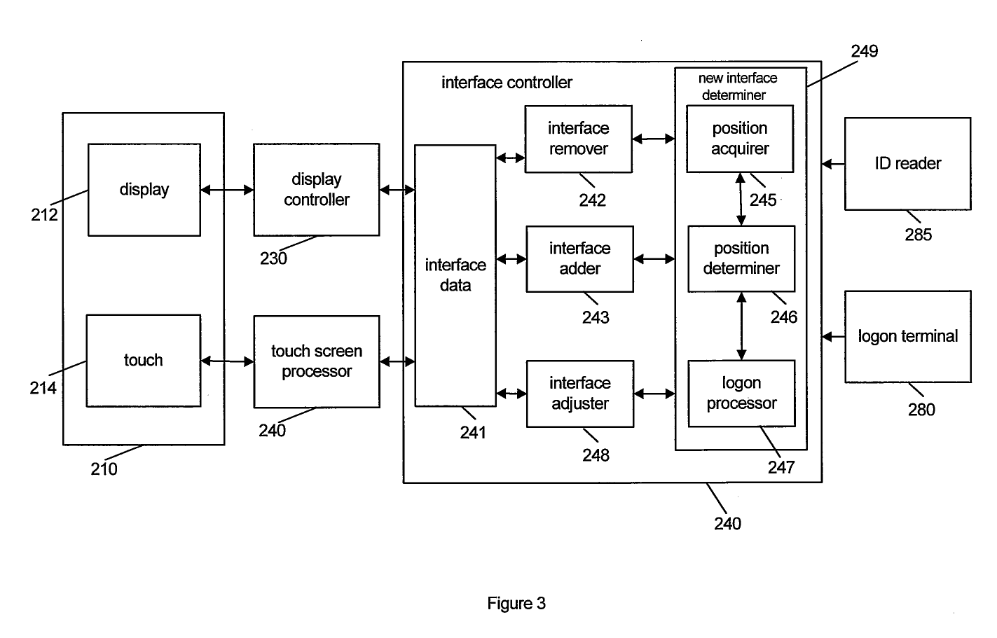

Referring to FIG. 3 there is shown more detail of the interface controller 240 as well as an alternative technique for determining where to add a new player interface. In FIG. 3 a single player interface 210 is shown. However it will be appreciated from the above that there are a plurality of player interfaces 210 provided by the virtual table.

In a first technique for adding a new player interface a player approaches log-on terminal 280 and request a player interface for the game either manually, or by swiping or otherwise providing a player tracking device to the log-on terminal 280. That is the log-on terminal may read magnetic cards, smart cards, RFID tags or other suitable data carriers.

The log-on processor 247 determines that a new player is to be added and requests that the position determiner 246 determine a position. Thus, the log-on processor 247 and position determiner 246 provide a new interface determiner 249. In one embodiment, there a series of predetermined positions that are available to players and the position determiner selects one of these predetermined positions. The positions data is provided to the interface adder 243 which updates the interface data 241. Similarly, the interface adjuster 248 determines whether any of the existing player interfaces specified by the interface data 241 need to be adjusted in order to accommodate the new player interface. The interface data is used by the display controller 230 to display additional player interface 210 for the new player. The player interface may initially show, for example, tokens for use in the game corresponding to a player's entered credit and/or a player hand in the case of a card game. The touch screen processor 240 then is able to determine from interface data 241 which portions of the touch screen 214 it needs to process in respect of this player such that data from the touch screen processor 240 represents player instructions for that player when it is subsequently passed to the outcome determiner 260.

The person may also use the log-on terminal to log out of the game or alternatively may operate the touch screen of the player interface to log out of the game. Interface remover 242 then removes the player interface from the interface data 241 and the interface adjuster 248 may adjust one or more other players interfaces as extra space is made available by the removed interface.

An alternative technique is also shown in FIG. 3 for determining to when add an additional interface and where it should be added. In this embodiment, the player is not required to use the log-on terminal and simply approaches and sits at the table, whereafter their position at the table is identified in some manner. In one technique, the player carries a player tracking device in the form of a RFID tag. When the player is within range of reader 285, the player's position is determined using reader 285 (which may include plural tag readers for triangulation) and their position is acquired by a position acquirer 245. Based on the acquired position data, the position determiner 246 determines a new position for the player either from a set of available positions or by defining a position relative to the players current location. An interface is then added in the manner described above by the interface adder 243. Accordingly, to accommodate this technique the new position interface determiner 249 includes the position acquirer 245. It will thus be appreciated that embodiments where players are assigned interfaces solely by this technique, the logon processor 247 is not needed.

Various techniques can be used to capture a player's position, for example, camera footage of the gaming table can be processed to determine that a new player has sat down at the table. When a player is added by this technique, they may be asked to confirm by means of a virtual keypad provided by the touch screen 214 of the player interface 210 that they wish to play. For example by entering a personal code linked to their identification means. Further, if there are a fixed number of positions a card reader could be provided at a player position in order for them to swipe a magnetic card.

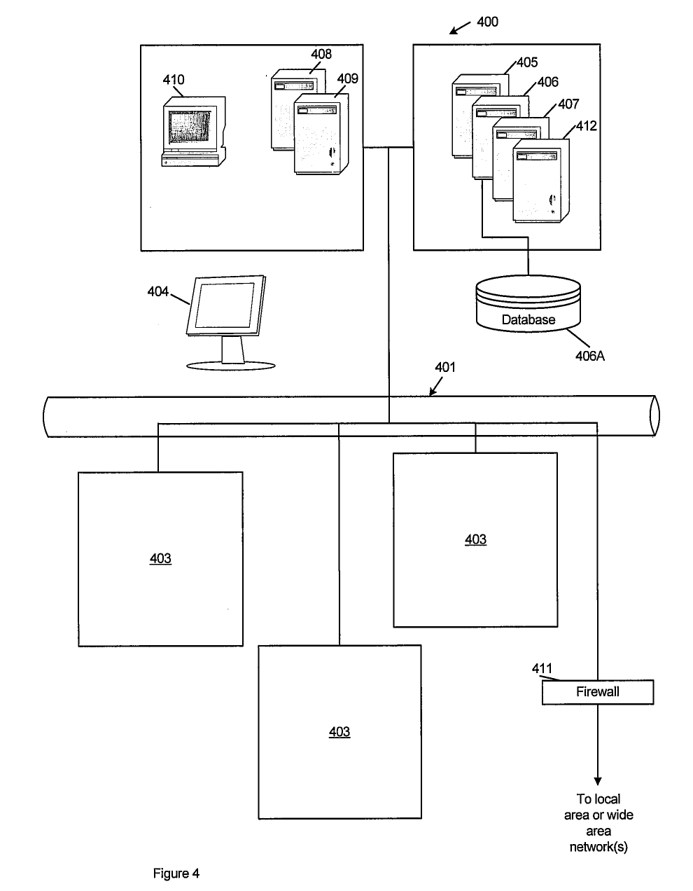

FIG. 4 shows a gaming system 400 in accordance with an alternative embodiment. The gaming system 400 includes a network 401, which for example may be an Ethernet network. Gaming tables 403, are connected to the network 401. The gaming tables 202 provide a player operable interface for the gaming system 400.

One or more displays 404 may also be connected to the network 401. The displays 404 may, for example, be associated with one or more gaming tables 203. The displays 404 may be used to display representations associated with game play on the gaming tables 402, and/or used to display other representations, for example promotional or informational material.

In a thick client embodiment, game server 405 implements part of the game played by a players using a gaming table 403 and the gaming machine 403 implements part of the game. With this embodiment, as both the game server and the gaming device implement part of the game, they collectively provide a game controller. A database management server 406 may manage storage of game programs and associated data for downloading or access by the gaming devices 402 in a database 406A. Typically, if the gaming system enables players to participate in a Jackpot game, a Jackpot server 407 will be provided to monitor and carry out the Jackpot game.

In a thin client embodiment (or networked gaming embodiment), game server 405 implements most or all of the game played by a player using a gaming table 403 and the gaming table 403 essentially provides only the player interface. With this embodiment, the game server 405 provides the game controller. The gaming table 403 will receive player instructions, pass these to the game server 405 which will process them and return game play outcomes to the gaming table 403 for display. A loyalty program server 412 may implement a loyalty system.

Servers are also typically provided to assist in the administration of the gaming network 400, including for example a gaming floor management server 408, and a licensing server 409 to monitor the use of licenses relating to particular games. An administrator terminal 410 is provided to allow an administrator to run the network 401 and the devices connected to the network.

The gaming network 400 may communicate with other gaming systems, other local networks, for example a corporate network, and/or a wide area network such as the Internet, for example through a firewall 411.

Persons skilled in the art will appreciate that in accordance with known techniques, functionality at the server side of the network may be distributed over a plurality of different computers. For example, elements may be run as a single “engine” on one server or a separate server may be provided. For example, the game server 405 could run a random generator engine. Alternatively, a separate random number generator server could be provided. Further, persons skilled in the art will appreciate that a plurality of games servers could be provided to run different games or a single game server may run a plurality of different games as required by the tables 403.

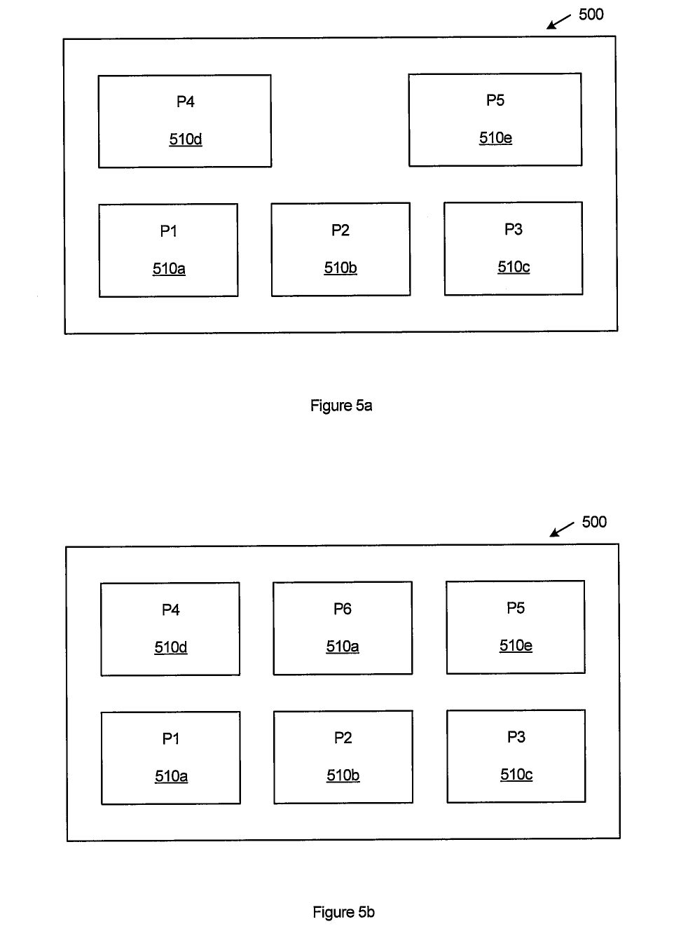

FIG. 5a shows one manner in which the display 120 may be adjusted in order to accommodate a new player interface. In FIG. 5a there are shown five player interfaces provided on a table 500. The interfaces 510 initially comprise three player interfaces of a first size 510a, 510b and 510c and two larger player interfaces 510d, 510e. The larger player interfaces 510d, 510e are provided because there are only two player interfaces on their side of the table, and hence more space is available for the players. whereas the three player interfaces on the other side of the table.

FIG. 5b shows player interface 510f added to the table. A person skilled in the art will appreciate that in FIG. 5b player interfaces 510d and 510e have been resized in order to accommodate the additional player interface 510, so that each player interface 510 is the same size.

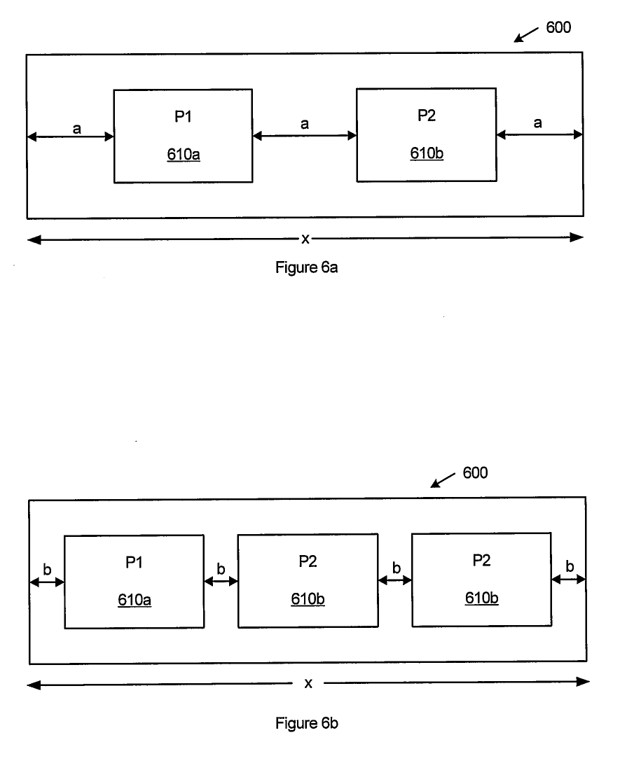

FIG. 6a shows an alternative technique in which a player interface can be added. In this embodiment, the size of any individual player interface 610 is always the same however the spacing a in FIG. 6a is larger than the spacing b in FIG. 6b while the table length x is maintained. Accordingly, the player interfaces 610 are always displayed so that they are evenly spaced across the entire length x of the table. A person skilled in the art will appreciate that the two techniques and other techniques can be employed to adjust the size, position or both the player interfaces.

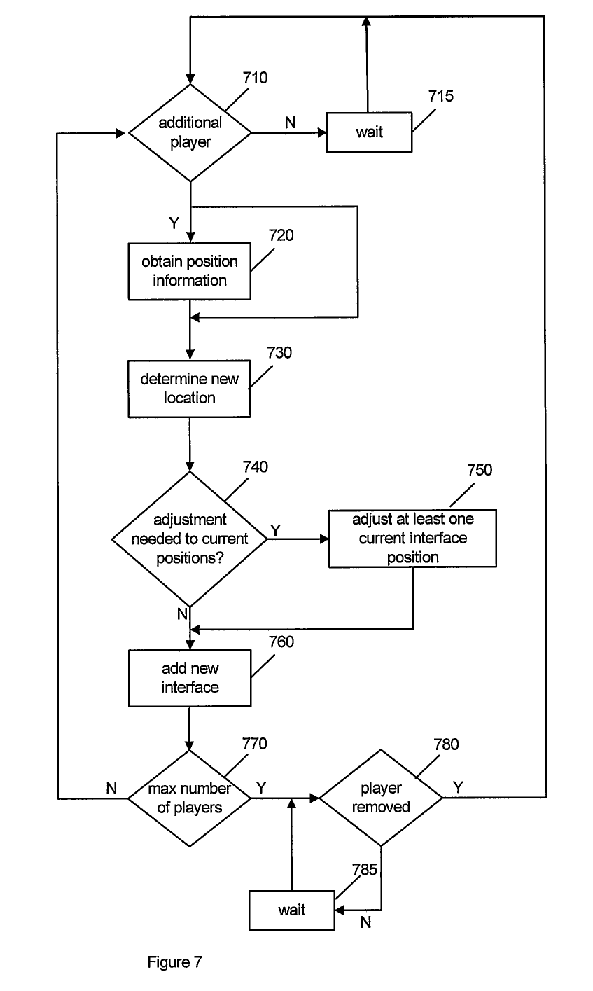

FIG. 7 shows the method of the embodiment. The virtual gaming table is initially awaiting a potential additional player 710 if there is no additional player the game enters the wait state 715. When an additional player is determined, in embodiments where the position of the player is acquired the position information is obtained 720 alternatively, or subsequently, the method proceeds to determining a new location 730 corresponding to the additional player interface. At step 740 it is determined whether an adjustment is needed to the current player interface positions, if the answer is “yes”, at least one current interface is adjusted 750 when the new interface is added 760. (Such an adjustment may be accompanied by a warning to the players that an adjustment is occurring.) As step 770 it is determined whether there are the maximum number of players playing with game. If the answer is “no” the method involves waiting for additional players 710, 715. If the answer is yes the method involves waiting until a player is removed 780, 785. When a player is removed the game can accommodate an additional player and accordingly moves to a wait state 710, 715. In other embodiments, players may be able to queue for the game using the logon terminal. In such embodiments, the method involves checking the queue when a player is removed from a full table.

One advantage of this game table is that the operator is able to select how big each player area is or to specify a minimum size for each player area. Thus, each player interface can be dynamically sized to reflect extra players being “squeezed” onto a table. Different configurations of player interfaces can be provided. For example, if the player table 100 is positioned against a wall, the common game area 122 can be moved to one side of the display. Such an arrangement would be typical for a blackjack game. Further, the appearance of the table can be adjusted and the gaming positions can be adjusted based on the game that is being played. Still further, an individual player interface can be resized depending on a particular characteristic associated with a player. For example, a player who is sight impaired may have a larger area than other players.

Further modifications will be apparent to persons skilled in the art and should be considered as falling within the scope of the invention described herein. In particular, features described above in relation to various embodiments may be combined to form further embodiments.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, the reference to prior art herein does not constitute an admission that the prior art forms a part of the common general knowledge in any country.

1. A method of controlling a touch screen display of a multi-player game comprising:
determining that an additional player interface is required for the game; and
adding to the touch screen display a new player interface operable to play the game.

2. A method as claimed in claim 1, wherein determining that an additional player interface is required comprises determining that a new player is to participate in the game.

3. A method as claimed in claim 1, wherein determining that an additional player interface is required comprises determining that an existing player requires an additional interface.

4. A method as claimed in claim 1, further comprising adjusting at least one existing player interface in response to addition of a new player.

5. A method as claimed in claim 4 comprising adjusting at least one existing player interface by moving an existing player interface.

6. A method as claimed in claim 4 comprising adjusting at least one existing player interface by changing the size of an existing player interface.

7. A method as claimed in claim 1 comprising determining a position for the new player interface based on the position of at least one existing player interface.

8. A method as claimed in claim 1 comprising obtaining position information indicative of a player's position relative to the display and determining a position on the player interface at which to add the new player interface based on the position information.

9. A gaming system for a multi-player game comprising:
a touch screen display;
a new interface determiner arranged to determine that an additional player interface is required for the game; and
a player interface adder arranged to add to the touch screen display, an additional player interface operable to play the game.

10. A gaming system as claimed in claim 9, wherein the new interface determiner is arranged to determine that an additional player interface is required by determining that a new player is to participate in the game.

11. A gaming system as claimed in claim 9, wherein the new interface determiner is arranged to determine that an additional player interface is required by determining that an existing player requires an additional interface.

12. A gaming system as claimed in claim 9, further comprising an interface adjuster arranged to adjust at least one existing player interface in response to addition of a new player.

13. A gaming system as claimed in claim 12, wherein the interface adjuster is arranged to adjust at least one existing player interface by moving an existing player interface.

14. A gaming system as claimed in claim 13, wherein the interface adjuster is arranged to adjust at least one existing player interface by changing the size of an existing player interface.

15. A gaming system as claimed in claim 9, comprising a position acquirer arranged to obtain position information indicative of the player's position relative to the display and a position determiner arranged to determine a position on the player interface at which the player interface adder adds the new player interface based on the position information.

16. A gaming system as claimed in claim 15, wherein the position acquirer comprises at least one sensor for sensing a player position.

17. A gaming system as claimed in claim 15, wherein the position acquirer comprises at least one identification reader for reading an identification device carried by the player.

18. A gaming system as claimed in claim 15, comprising a plurality of identification readers arranged to enable the player's position to be determined.

19. A gaming system as claimed in claim 9, wherein the display is mounted so that an upper surface thereof is substantially horizontal such that the display provides a virtual table.

20. A gaming system as claimed in claim 9, wherein the display comprises a plurality of display sub-units.

21. A method as claimed in claim 1 including a computer program code and further comprising executing said computer program code to carry out said method.

22. A method as claimed in claim 21 including a computer readable medium providing said computer program code.

23. A method as claimed in claim 21 and further including a data signal comprising said computer program code.

24. A method as claimed in claim 21 and further comprising transmitting said computer program code.

25. A method as claimed in claim 21 and further comprising receiving said computer program code.
